(19) United States
(12) Patent Application Publication
(10) Pub. No.: US 2009/0005016 A1
(43) Pub. Date: Jan. 1, 2009

(54) APPARATUS AND METHOD TO MAINTAIN A CONTINUOUS CONNECTION OF A CELLULAR DEVICE AND A SENSOR NETWORK

(76) Inventors: Betty Eng, Portland, OR (US); Kofi Cobbinah, Houston, TX (US); Janna C. Kimel, Portland, OR (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/771,869

(22) Filed: Jun. 29, 2007

(51) Int. Cl. H04M 3/42

(52) U.S. Cl. 455/414.1

(57) ABSTRACT

Embodiments of the present invention provide devices and methods that allow a continuous connection to be maintained between a medical device that is capable of communicating over a cellular network and a sensor network. Medical devices that are capable of communicating over a cellular network represent one form of assistive technologies for the home that can allow senior citizens to remain at home for longer, improve the quality of life, and provide more cost-effective solutions than residential care. Removing a SIM card (subscriber identity module, a removable smart card for cell phones that securely stores the service-subscriber key used to identify a mobile phone) from a cellular communication device requires the device to be powered down. However, powering down a medical device can result in a loss of important data.

### BACKGROUND OF THE INVENTION

1. Field of the Invention

The embodiments of the present invention relate generally to medical devices and equipment, and more specifically to sensor networks for gathering physiological, vital sign, and activity data for users and the transferal of the data gathered over a cellular network to a caregiver.

2. Background Information

As the world's population ages, more and more countries face the increasing challenge of caring for an ageing population. The use of assistive technology in the home can enable senior citizens to feel more secure and independent. Additionally, assistive living technologies that allow senior citizens to remain at home for longer improve the quality of life and can be more cost-effective than residential care.

As part of a technology-enabled assistive living arrangement, sensors may be implemented to monitor an individual's activities and physiological health. As part of a system to monitor physiological health, a person's body may be equipped with a variety of sensors and medical monitors, such as for example, heart rate, cardiac EKG (electrocardiogram), EEG (electroencephalography), blood pressure, temperature, spirography, and respiration monitors, and pulse oximeters. In the medical communication environment, the wireless connectivity between devices from a person's body to a device for capturing medical data is known as the Wireless Body Area Network (WBAN). A WBAN typically has a range of about 6-10 meters. The wireless connectivity between the device for capturing medical data and existing cellular networks is known as the Wireless Local Area Network (WLAN). A WLAN typically has a range of about 60 meters.

Health-centered computing devices, as well as GSM (global system for mobile communication, a cellular network and the most-used and most ubiquitous standard for mobile phones) cell phones and laptop computers currently entering the market with 3G data connectivity (third generation technology for mobile phone standards which includes wide-area wireless voice telephony and broadband wireless data in a mobile environment), require a user to power down the system or to remove the battery pack in order to add or remove the SIM card (subscriber identity module, a removable smart card for cell phones that securely stores the service-subscriber key used to identify a mobile phone). A user domiciled in one area who travels across the country or out of the country with cellular-supported devices may need to replace SIM cards from the devices with local regional network-supported SIM cards in order to make a cellular connection in a different area. For non-medical devices, taking the few minutes to power down the system to replace the SIM card may be an inconvenience, but not a significant problem. However, this is not necessarily the case for medical and health-related devices. The few minutes it takes to power down the system to replace the SIM card may result in critical information being lost. Data that is lost cannot be transmitted to the data recipient(s), which may include emergency services, medical personnel, care providers and the user's loved ones.

Further, in a similar manner in which a user's phone book gets stored locally on the cell phone SIM card, the SIM card in a medical device may store data collected from sensors, and the user's medical history and medication details. Thus, should a SIM card be lost or missing, vital personal identification data is lost.

Thus a need exists for a system that allows a SIM card to be removed from a device without causing a loss of data.

### BRIEF DESCRIPTION OF THE FIGURES

FIG. 1 provides a basic schematic diagram of an cellular-enabled communication network in which data can be gathered from sensors and sent to a third party via a cellular network.

FIG. 2 provides a flow diagram demonstrating the operation of an exemplary cellular-enabled communication network in which health-related monitoring data (such as physiologic data, vital signs, and or behavior-related data) is gathered on a base station platform and sent via cellular network to caregivers during the removal of a SIM card from the base station.

### DETAILED DESCRIPTION OF THE INVENTION

Assistive living technologies may encompass, for example, technologies that monitor fitness or wellness, and are used in family care, assisted living, remote assisted living, chronic disease care, transitional care, and or early release health care situations. Many assistive-living technologies incorporate a cellular feature to allow a patient's or user's medical status data or alerts to be sent to a care-giver or medical provider over existing cellular infrastructures. In order to use the GSM-based cellular features of these assistive living technologies, a SIM card is required to enable connectivity from the medical device to the cellular network. A problem arises when the SIM card needs to be removed from the medical device. Since SIM card circuits have a designated power pin as well as two differential signal pins, hot-swapping of the SIM cards with the rest of the system powered-on creates both an electrical and safety concern. Thus when a SIM card is removed from a system or a device, the system or device must be completely powered down. Additionally, the SIM card may contain important user-specific information and or medical and or physiological wellbeing data that has been collected over time.

With current implementation of SIM cards, both in the medical and consumer devices, when a SIM card is removed from the device/system, the device must be completely powered down. In the medical communication environment, both the WBAN and WLAN connectivity is broken when the device/system is powered down. Embodiments of the present invention provide for WBAN connectivity even though the WLAN connection is broken. Additionally, embodiments of the present invention provide for data storage and archiving before the SIM card is removed and while the card is absent from the system so that missing data can be loaded onto the SIM card once it is inserted into the device. Once an area-supported SIM card is inserted in a medical device, data collected while the WLAN-link was missing, is now retrieved from memory and transmitted over cellular networks. Hence, life critical data is captured when WLAN connectivity is unavailable, and transmitted once WLAN connectivity is restored.

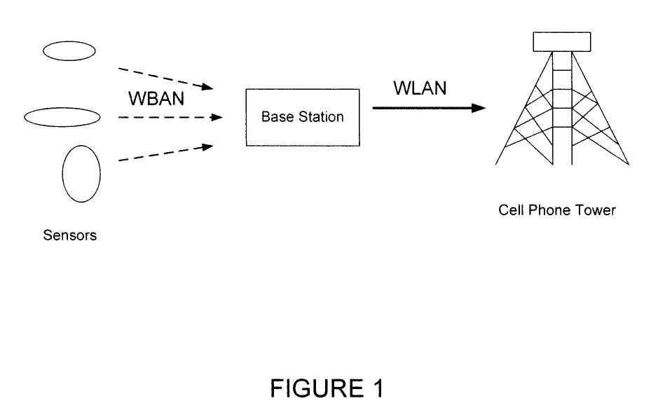

FIG. 1 provides a general scheme for the operation of an assistive living health and behavioral monitoring system. In this example, data is relayed from sensors either through wires or wirelessly to a base station. As described more fully herein, the sensors may, for example, report about behavior or physiological condition, and be devices such as accelerometers (either mounted or body-worn), pulse oximeters, heart rate, cardiac EKG (electrocardiogram), EEG (electroencephalography), blood pressure, temperature, spirography, and or respiration monitors. The base station may, for example be a personal digital assistant (PDA), a handheld device, a laptop type computer, or a desktop device and the base station may perform core functions such as data aggregation, storage, processing, and display and may be able to provide local alerts and alerts via a cell phone network. The data collected from the sensor(s), either in an unprocessed form or a processed, aggregated, or analyzed form is then sent to one or more remote locations, such as doctors or nurses offices, emergency services, care-givers and or family members via a cellular connection. The base station may additionally optionally have features, functions, and associated peripherals typically found in personal computers, PDAs, and or phones.

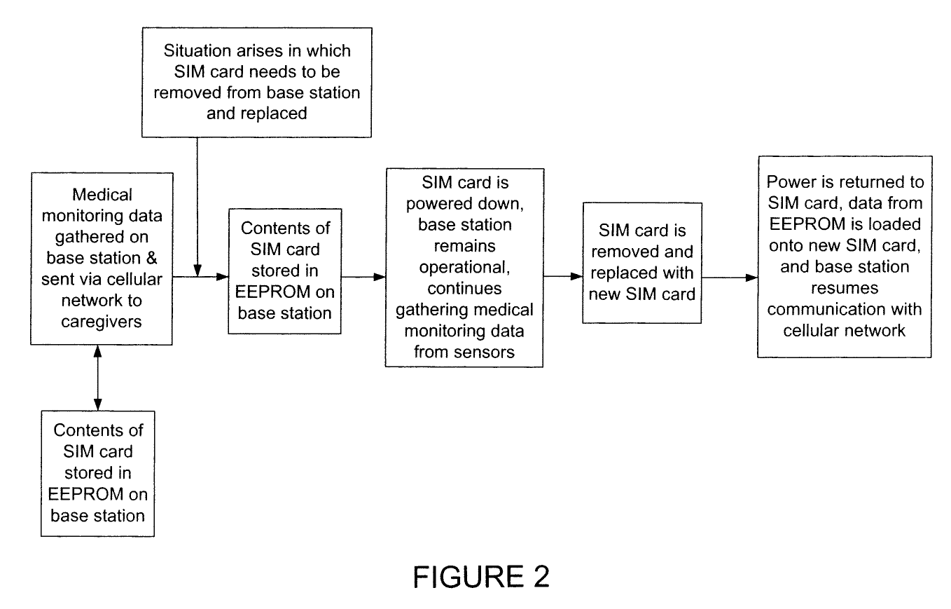

FIG. 2 provides a flow diagram of the operation of an exemplary assistive living health and behavioral monitoring system. In FIG. 2, a medical monitoring base station receives information from one or more sensors, stores the information received in memory, and periodically sends the information to remote parties via a cellular connection. In the event that the SIM card needs to be removed, the attempt to remove the SIM card triggers a shutting down process in which the contents of the SIM card are stored in non-volatile memory, such as EEPROM (electrically erasable programmable read-only memory), before the SIM card is powered down and the user is allowed to remove the SIM. Optionally, the contents of the SIM card may be periodically backed up in memory to avoid loss of data if the SIM becomes damaged or is accidentally removed. When a SIM card is inserted in a medical device, data is transported from the SIM card to a non-volatile memory device, like an EEPROM, which in essence, dynamically backs up all the data off the SIM card to an integrated circuit (IC) located on a motherboard. In essence, the EEPROM is a ghost-image of information of the actual SIM card. If SIM card is held in place with a SIM card holder, with a hinged door to lock/unlock the SIM card, for example, when the SIM card door is open, power is removed on the Vcc pin of the SIM circuit via the memory device, while keeping the rest of the medical device powered. With the SIM card door open, the base station will continue to communicate with the sensors via Bluetooth or other wired or wireless communication protocol and to store the data obtained from the sensors. Although no information can be sent via cellular, data communicated between the sensors and the base station is stored in memory and sent over cellular once a SIM card is detected. Thus, no information is lost, and information is sent from memory at a delayed time. For security purposes, retrieving a data from the memory device can be under password protection to avoid compromising of personal privacy. Optionally, the SIM card may be powered down without storing its contents in memory. In this case the base station does not store data obtained from the sensors on the SIM card only.

In general, a base station or base platform is a device that is capable of capturing data from sensors and transmitting it via a cellular network to a remote third party that is not present at the location of the sensors. A base station may refer to any device having a processing system, a memory, and a mobile power source or supply, such as one or more batteries or solar cells, for example. The data capture by the base station from the sensors occurs in a wired or in a wireless manner. Exemplary devices that can serve as base stations include, PDAs, mobile computing devices, mobile computers, computers dedicated to medical, health, and or physiological monitoring, laptop and desktop computers, and mobile computers. The base station may serve not only to collect output from the sensors, but it may also aggregate and analyze the data before sending it out via the cellular network. The base station may be equipped to provide local alerts based on the results of the sensor output data aggregation and or analysis. The base station optionally further comprises a user interface screen that may be a touch screen. Although a number of functionalities are discussed herein, embodiments of the present invention are not so limited and additional functionalities are possible, such as those commonly available with a laptop computer, ultra-laptop computer, portable computer, handheld computer, palmtop computer, personal digital assistant (PDA), cellular telephone, combination cellular telephone/PDA, smart phone, pager, one-way pager, two-way pager, messaging device, data communication device, and or a music player (such as a mp3 player). Such functionalities include, for example, an ability to send and or receive text messages, the ability to send or receive phone calls, to send and receive email, to store and access lists of contacts and important personal information, and an ability to calendar important dates and appointments. Additional functionalities include, the ability to connect to the internet with either a hard connection or a wireless connection. In the case where the base station contacts multiple remote parties, the communication network system should preferably support multicast semantics. A computer equipped with a wireless receiver/transmitter is an example of one type of device that could serve as a base station. Such computers could be used singly or in groups.

The systems of the present invention may be implemented as wireless systems, wired systems, or a combination of both. When implemented as a wireless system, base stations and sensors may include components and interfaces suitable for communicating over a wireless shared media, such as one or more antennas, transmitters, receivers, transceivers, amplifiers, filters, control logic, and so forth. An example of wireless shared data may include portions of a wireless spectrum, such as the RF spectrum. Examples of wireless communication methods include, Bluetooth (based on IEEE 802.15.1 specifications), ZigBee (based on IEEE 802.15.4 standards for wireless personal networks), wireless local area networks (WLAN), Wi-Fi (wireless fidelity, WLAN based on IEEE 802.11 standards), Wi-Pro, WiMax (worldwide interoperability for microwave access, based on IEEE 802.16 standards), enocean, and GPS (global positioning systems). When implemented as a wired system, a transformation device may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, and fiber optics.

Although EEPROM is used in examples herein as a nonvolatile memory capable of storing the image of a SIM card, the invention is not limited to a particular type of memory for the storage of the SIM card image. In general, nonvolatile memory or nonvolatile storage is computer memory that can retain the stored information when the computer is powered down. In contrast, volatile memory requires power to maintain the stored information. Most forms of random access memory are volatile storage, including dynamic random access memory and static random access memory. Nonvolatile memory includes, for example, flash memory, EPROM (erasable programmable read-only memory), and EEPROM. EEPROM is a nonvolatile storage chip typically used to store small amounts of volatile or configuration data. Volatile memory includes, for example, DRAM (dynamic random access memory) and SRAM (static random access memory). Nonvolatile memory has the advantage that the contents of the SIM card can remain intact even if the base station is accidentally powered down while the SIM card is removed.

Exemplary sensors that may be used in embodiments of the invention, include for example, the sensors that may, report about behavior, physiological condition, or patient vital signs, and be devices such as accelerometers, pulse oximeters, heart rate, cardiac EKG (electrocardiogram), EEG (electroencephalography), blood pressure, temperature, spirography, glucometers, respiration monitors, and infrared (IR) sensors that report about activity and or temperature. Further, sensors may report about an individual's activities or movements. Sensors may be body-mounted or stationary. The base station may receive information from one or more sensors. One or more base stations may be employed at a location to receive information from sensors and or other base stations. Sensors may perform functions such as monitor heart health and detect arrhythmia for patients for study and or research purposes or provide early warnings or preventative care for potential incidents that negatively impact health. Heart health studies, for example, enable patients to avoid or attenuate stimuli long term, enable early intervention when early warning signs are detected, may attenuate severity of an episode through early detection and treatment. The remote location or caregiver could also be informed of the geographic location of the patient through the use of GPS technology built into the base station.

Further sensor examples include, disposable sensors that are attached to a patient's body such as that currently employed for applications such as electrocardiography (ECG/EKG) and electroencephalography (EEG) monitoring. The sensor could be an active and/or passive sensor, including a chemical sensor or a dermal patch. Additional sensors could be included for measuring levels of particular chemicals and/or medications within a patient's body. The sensor could be affixed to a patient's body or could be located subcutaneously. According to one embodiment of the invention, the sensor could include a micro-sensor, a biodegradable micro sensor, or other sensors produced using micro-machine technology.

Generally, a patient vital sign is any measurable presence and/or level of particular substances, rates, or conditions which could affect an individual's health. Patient vital sign data could represent any physiological variable or combination or variables including but not limited to a heart rate, heart beat, heart murmur, heart intensity, a pulse at extremities, blood glucose, blood oxygen content, blood pressure, acoustic monitoring of lung function, respiration rate, occlusion such as an occlusion of air flow the lung and blocked blood flow in veins or arteries, adrenal level, acetylcholine level, temperature, sodium levels, activity level for obesity and geriatric care, three axis acceleration to detect falling. Patient vital signs may also include indicia of other diseases.

In some embodiments, one or more monitoring devices or mote-based sensors are attached to a patient. The monitoring device senses an electrical signal associated with patient vital sign, locally processes or conditions the signal, and then wirelessly transmits the signal to a base station for further processing and/or diagnosis. The sensed signal having patient vital sign data could be processed locally within the monitoring device, e.g., by a digital processor or microprocessor, and then transferred via a wired connection and/or wirelessly by a transceiver.

The wireless health monitoring device of the embodiments of the invention could be attached to a patient and used for long-term monitoring of patient vital signs or for ad hoc deployment in an emergency situation. It could also be deployed in a hospital, for example, by using fixed, powered gateway nodes that could provide access to a wired network infrastructure.

In some embodiments, the monitoring device could transmit and receive a signal to the base station by both wireless and hard-wired connections such as Ethernet. The wireless standard could be a 2.4 GHz WLAN or IEEE 802.11 Standard (802.11, 1999/8802-11 (International Organization for Standardization/International Electrotechnical Commission) (ISO/IEC) 8802-11:1999), for example. In further embodiments, multiple monitoring devices could be present on the same network.

In another embodiment, the sensors can include reliable communications. Although intermittent data packet loss due to interference may be acceptable, persistent data packet loss due to congestion or node mobility could degrade system performance. The sampling rates may range anywhere from less than 1 Hz to 1000 Hz or more for wireless transmission of data to and from the wireless monitoring device.

An embodiment of the invention can be used as part of a larger treatment program. In one exemplary embodiment of the invention, the monitoring device could combine pulse oximetry with EKG to monitor effectiveness of respiratory therapy, correlating heart rate and pulse rate.

The sensors and the base station also could include a visual and/or audible power source indicator to indicate that the level of the charge of the battery pack of the monitoring device, thereby providing the patient a warning to recharge the battery pack before the charge is depleted. The battery pack could be charged using a conventional electrical adapter and/or a cradle unit. The electrical adapter and/or the cradle unit could be configured to function as a wireless gateway. The monitoring device could be completely operative when the battery pack is charging, for example, by connecting the leads of the electrical adapter to the monitoring device without removal of the monitoring device from the body of the patient.

In some embodiments, a memory in the base station, such as the SIM card, could contain information regarding a patient including a patient profile. The patient profile could be initially programmed or could be established over a period of time by monitoring a patient. The patient profile could include normal ranges of patient vital sign data of a particular patient and of the general population. In addition, the patient profile could include a patient's body weight, height, ranges of different hormone levels, average heart rate, average respiration rate, medical history, a list of substances to which the patient is allergic, current medication being taken and/or subscribed to the patient, and timing information, such as the time and date of last medication delivery for a particular substance. The digital processor could compare patient vital sign data received from one or more sensors with the stored patient profile. Any detection of a sensed signal that is outside of the normal ranges of the stored patient profile could indicate a potential health problem.

In one embodiment of the invention, the monitoring device could render patient vital sign data in a form that is appropriate for a medical application for which the data would be applicable (for example, cardiac and neurologic monitoring or diagnostics). This software may also correct for any signal artifacts and/or condition the data. The software may be stored and executed on either the monitoring device or on the base station.

The embodiments of the invention could be realized in hardware, software, or a combination of hardware and software. The embodiments of the invention could achieve many goals: medical data acquisition, processing, aggregation and wireless communication, some or all integrated into a holistic embodiment that achieves overall low power consumption, network efficiency and robustness of performance under varying conditions. The base station capabilities may further include, but are not limited to, multi-antenna transmission and reception as well as the capability to track data from multiple sets of monitoring devices simultaneously.

Hypothermia and hyperthermia can affect senior citizens especially severely. This is due to the ageing process, reduced activity and for some, challenging financial circumstances meaning that minimum heating or cooling is available in their home. Thus, temperature monitors, for example, worn either on the body or placed around the home, can help to prevent life-threatening incidences due to lack of heat or air conditioning.

Pulse oximetry is a non-invasive technology used to reliably assess two patient health metrics: heart rate (HR) and blood oxygen saturation (SpO₂). These parameters could yield useful information, particularly in emergencies when a sudden change in the heart rate or reduction in blood oxygenation could indicate a need for urgent medical intervention. Pulse oximetry could provide advance warning of the onset of hypoxemia even before a patient manifests physical symptoms.

A pulse oximeter typically has a plastic housing that slips over the index finger or earlobe. Pulse oximetry is performed by projecting an infrared or near infrared light (typically from light emitting diodes) through blood vessels near the skin and detecting the amount of light absorbed by hemoglobin in the blood at two different wavelengths (typically, 650 nm and 805 nm) by optoelectronic sensor, thereby determining the level of oxygen saturation. The heart rate could be correlated to the pattern of light absorption over time, since blood vessels contract and expand with the patient's pulse. Computation of HR and SpO₂ from the light transmission waveforms could be performed using a digital signal processing (DSP) technique. The present invention can be configured as a wireless pulse oximeter constructed from products that could provide self-contained logic for driving the LEDs and performing the HR and SpO₂ calculations

An EKG measures electrical activity of the heart by the connection of between twelve and fifteen leads to a patient's chest, arms and right leg via adhesive foam pads. The device could record the heart's electrical activity (either continuously or for short periods) between different pairs of electrodes. Each pair of leads could provide a unique and detailed picture of the cardiac rhythm, an individual echo of the heart's electrical impulses as measured by the EKG.

An embodiment of the invention can be configured as a wireless monitoring device that provides continuous or intermittent EKG monitoring by measuring the differential across a single pair of electrodes could incorporate an amplifier, a multitude of passive components, a microprocessor and a battery pack. Connectors could be provided to three leads that attach to the patient's upper and lower chest. A first lead could serve as a pseudo-ground, while the second and third leads could be used to measure cardiac activity. A differential signal could be generated by comparing the signals from the second and third leads with the signal from the pseudo-ground. The differential signal contains EKG vital sign data. The amplifier could amplify the differential signal by a factor of 5 or more and the passive components and/or the microprocessor could filter out almost all common-mode noise. A high-pass feedback filter could dynamically correct any DC shift that may occur over time. The differential signal could subsequently passes to an op-amp that provides further amplification and acts as a low-pass filter. The resulting signal, which also contains EKG vital sign data, could be routed to a transceiver where a component could sample the resulting signal and/or EKG vital sign data at a configurable frequency (typically 120 Hz) and transmit the EKG signal to a base station.

Various embodiments of the present invention may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments or aspects of embodiments may be implemented, for example, using a machine-readable or computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, or Digital Versatile Disk (DVD). The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices.

We claim:

1. A method for preventing loss of health related data comprising:
providing a device capable of communicating with one or more sensors that is capable of sensing and transmitting information, wherein the information is related to physiologic data, vital signs, or behavioral monitoring associated with a user, wherein the device is capable of communicating with a cellular network, and wherein the device comprises a subscriber identity module card, a processor, and memory, wherein the subscriber identity module card contains user-related information;
storing the user-related information contained on the subscriber identity module card in the memory;
removing the subscriber identity module card while the subscriber identity module card is powered down and while maintaining power to the device; and
replacing the subscriber identity module card in the device and returning power to the subscriber identity module card.

2. The method of claim 1 wherein the memory is nonvolatile memory.

3. The method of claim 2 wherein the nonvolatile memory is selected from the group consisting of EEPROM, EPROM, and flash memory.

4. The method of claim 1 wherein the memory is volatile memory.

5. The method of claim 1 wherein the device is capable of communicating wirelessly with one or more sensors.

6. The method of claim 5 wherein the wireless communication occurs via Bluetooth, ZigBee, wireless local area networks, wireless fidelity, or WiMax.

7. The method of claim 1 wherein the sensor is selected from the group consisting of accelerometers, pulse oximeters, heart rate monitors, electrocardiogram sensors, electroencephalography sensors, blood pressure monitors, temperature monitors, spirographic monitors, glucometers, respiration monitors, and combinations thereof.

8. A health monitoring device capable of communicating with a cellular network comprising:
a processor;
a housing capable of accepting a subscriber identity module card and operably connecting the subscriber identity module card to the processor,
a memory capable of storing the contents of the subscriber identity module card;
a power allocation structure wherein power to the subscriber identity module card may be removed while power to the rest of the device remains intact;
a communication structure capable of accepting data from one or more sensors;
a second communication structure capable of communicating data obtained from the one or more sensors through a cellular network.

9. The device of claim 8 wherein the memory is nonvolatile memory.

10. The device of claim 9 wherein the nonvolatile memory is selected from the group consisting of EEPROM, EPROM, and flash memory.

11. The device of claim 8 wherein the memory is volatile memory.

12. The device of claim 8 wherein the device is also capable of aggregating and analyzing the data received from the one or more sensors.

13. The device of claim 8 wherein the sensor is selected from the group consisting of accelerometers, pulse oximeters, heart rate monitors, electrocardiogram sensors, electroencephalography sensors, blood pressure monitors, temperature monitors, spirographic monitors, glucometers, respiration monitors, and combinations thereof.

14. The device of claim 8 wherein the device is capable of communicating wirelessly with one or more sensors.

15. The device of claim 14 wherein the wireless communication occurs via Bluetooth, ZigBee, wireless local area networks, wireless fidelity, or WiMax.

16. The device of claim 8 also including global positioning system capability.

17. The device of claim 8 wherein the device is a hand-held device, a personal digital assistant, a laptop computer, a desktop computer, or a dedicated computer system for health monitoring.
